(19) United States
(12) Patent Application Publication
(10) Pub. No.: US 2005/0288813 A1
(43) Pub. Date: Dec. 29, 2005

(54) Direct write and freeform fabrication apparatus and method

(76) Inventors: Laixia Yang, Fargo, ND (US); Mohammad Rastgaar Aagaah, Fargo, ND (US); Mohammad Mahinfalah, Fargo, ND (US); Bor Z. Jang, Fargo, ND (US); Dean G. Grier, Hawley, MN (US)

Correspondence Address: JOHN P. O'BANION;O'BANION & RITCHEY LLP, 400 CAPITOL MALL SUITE 1550, SACRAMENTO, CA, 95814, US

(21) Appl. No.: 11/207,229

(22) Filed: Aug. 19, 2005

Related U.S. Application Data
(63) Continuation of application No. PCT/US04/33964, filed on Oct. 13, 2004.
(60) Provisional application No. 60/511,517, filed on Oct. 14, 2003.

(51) Int. Cl. G06F 19/00

(52) U.S. Cl. 700/119

(57) ABSTRACT

A direct write or freeform fabrication apparatus and process for making a device or a three-dimensional object. By way of example the method comprises: (a) providing a target surface on an object-supporting platform; (b) operating a material deposition sub-system comprising a liquid deposition device for dispensing at least a liquid composition and a solid powder-dispensing device for dispensing solid powder particles to selected locations on the target surface; (c) operating a directed energy source for supplying energy to the dispensed liquid composition and the dispensed powder particles to induce a chemical reaction or physical transition thereof at the selected locations; and (d) moving the deposition sub-system and the object-supporting platform relative to one another in a plane defined by first and second directions to form the dispensed liquid composition and the dispensed powder particles into the device or object. An apparatus is also provided for carrying out this process.

### CROSS-REFERENCE TO RELATED APPLICATIONS

This application claims priority from, and is a 35 U.S.C. § 111 (a) continuation of, co-pending PCT international application number PCT/US2004/033964, filed Oct. 13, 2004, incorporated herein by reference in its entirety, which claims priority from U.S. provisional application Ser. No. 60/511,517, filed on Oct. 14, 2003, incorporated herein by reference in its entirety.

### STATEMENT REGARDING FEDERALLY SPONSORED RESEARCH OR DEVELOPMENT

This invention was made with Government support under Grant No. DMEA90-02-C-0224, awarded by the Department of Defense. The Government has certain rights in this invention.

### INCORPORATION-BY-REFERENCE OF MATERIAL SUBMITTED ON A COMPACT DISC

Not Applicable

### NOTICE OF MATERIAL SUBJECT TO COPYRIGHT PROTECTION

A portion of the material in this patent document is subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. § 1.14.

### BACKGROUND OF THE INVENTION

1. Field of the Invention

This invention pertains generally to solid fabrication systems, and more particularly to an apparatus and method for performing free form fabrication.

2. Description of Related Art

Solid freeform fabrication (SFF), or layer manufacturing, is a new rapid prototyping technology that builds a three-dimensional (3-D) object in a layer-by-layer or point-by-point manner. Prior to physically building up the object, the process begins with creating a computer aided design (CAD) file to represent the image or drawing of a desired object. This object image file is further sliced into a large number of thin layers with the contours of each layer being defined by a plurality of line segments or data points connected to form polylines. The layer data is converted to tool path data, typically represented by computer numerical control (CNC) codes such as G-codes and M-codes. These codes are then utilized to drive a fabrication tool for building an object layer-by-layer.

This SFF technology enables direct translation of the CAD image data into a three-dimensional (3-D) object. The technology has enjoyed a broad array of applications such as verifying a CAD database, evaluating design feasibility, testing part functionality, assessing aesthetics, checking ergonomics of design, aiding in tool and fixture design, creating conceptual models, creating sales/marketing tools, generating patterns for investment casting, reducing or eliminating engineering changes in production, and providing small production runs.

Increasing interest has been directed toward using inkjet print technology in 3-D fabrication techniques Inkjet printing involves ejecting fine polymer or wax liquid droplets from a print-head nozzle that is either thermally activated or piezo-electrically activated. The droplet size typically lies between 30 μm and 50 μm, however, it can be directed to droplet sizes at, or below, approximately 13 μm. The small droplet size generally implies that inkjet printing could offer a high part accuracy. Unfortunately, inkjet technology is only applicable to dispensing liquids in a limited viscosity range, which leaves out a majority of preferred materials for performing 3-D fabrication, such as solid powders with high melting points.

One industry investigator (Sachs, et al. within U.S. Pat. No. 5,204,055, issued April 1993) discloses a 3-D printing technique that involves using an inkjet to spray a computer-defined pattern of liquid binder onto a layer of uniform-composition powder. The binder serves to bond together those powder particles on those areas defined by this pattern. Those powder particles in the un-wanted regions remain loose or separated from one another and are removed at the end of the build process. Another layer of powder is spread over the preceding one, and the process is repeated. The “green” part made up of those bonded powder particles is separated from the loose powder when the process is completed. This procedure is followed by binder removal and metal melt impregnation or sintering.

In another technique referred to as selected laser sintering (SLS) technique (i.e. described in U.S. Pat. No. 4,863,538) a full-layer of powder particles is spread while a computer-controlled, high-power laser is utilized to partially melt these particles at desired spots. Commonly used powders include thermoplastic particles or thermoplastic-coated metal and ceramic particles. The procedures are repeated for subsequent layers, one layer at a time, according to the CAD data of the sliced-part geometry. The loose powder particles in each layer are allowed to stay as part of a support structure. A sintering process is then performed, which although it does not always fully melt the powder, allows molten materials to bridge between particles.

Most of the prior-art layer manufacturing techniques have been substantially limited to the production of parts from homogeneous material compositions. Furthermore, due to the specific solidification mechanisms employed, many other techniques are limited to the production of parts from specific polymers. For instance, stereo lithography relies on ultraviolet (UV) light induced curing of photo-curable polymers such as acrylate and epoxy resins.

One layer manufacturing technique which overcomes some of these drawbacks is described in a “Rapid Prototyping and Tooling System,” described within U.S. Pat. No. 6,405,095 issued Jun. 11, 2002. This process includes providing a focused heat source (i.e. a laser beam) to maintain a small pool of molten material on the surface of a movable stage. The material in this pool is replenished, continuously or intermittently, by injecting metal and/or ceramic powder into this pool. The stage is controlled to move relative to the heat source to trace out the geometry of a bulky portion of a first layer for the desired object. The “scanning” of this pool (heat source-powder interaction zone) leaves behind a strand of molten material which substantially solidifies immediately after the material moves out of the heat-affected zone.

Other portions of an object, particularly those containing fine features of a layer, are built by ejecting and depositing fine liquid droplets for improved accuracy. These two procedures are repeated concurrently or sequentially under the control of a CAD computer to deposit consecutive layers in sequence, thereby forming the desired 3-D object. This is an interesting SFF process that is specifically designed for the purposes of rapid prototyping and rapid tooling of highly accurate 3-D objects, but does not facilitate the direct-writing of microelectronic components. Indeed, most of the prior-art techniques are not directly applicable for direct write manufacturing of microelectronic or MEMS devices.

It should be appreciated that direct write manufacturing (DWM) techniques are utilized for creating device patterns directly on a substrate, either by adding material or removing material from a substrate, without the necessity of masks, pre-existing forms, or tooling. DWM technologies have been developed in response to a need in the microelectronics industry for a means to rapidly prototype passive circuit elements on various substrates. These elements are typically fabricated at the mesoscopic scale, such as within a size range between conventional microelectronics (sub-micron range) and traditional surface mount components (10+ mm range). It should be noted that, although direct writing may also be accomplished in the sub-micron range using electron beams or focused ion beams, these techniques are not appropriate for large scale rapid prototyping due to their small scale and, hence, low deposition rates.

One major advantage of DWM technologies is that they allow circuits to be prototyped without the need for iterative design and fabrication of photolithographic masks. The DWM techniques, therefore, facilitate rapid and inexpensive performance evaluation of circuits. Another advantage with DWM techniques lies in their potential for reducing real estate on printed circuit boards and other substrates, through functional integration of minute active and passive elements. By way of example, using DWM it would be possible to incorporate electronic elements onto any desired substrate, including odd-shaped substrates such as the conformal printing of communication circuits directly onto a soldier's helmet or eyeglass frame. Many other application areas exist, for example integrating circuitry with displays, such as circuits being integrated upon LCD, EL, electronic ink displays, and so forth. Applications abound for DWM technology, which provides a method of circuit manufacture and customization.

Direct writing can be controlled with CAD/CAM programs, thereby permitting electronic circuits to be fabricated by machinery operated by unskilled personnel or allowing designers to move quickly from a design to a working prototype. Meso-scaled DWM technologies may also find applications in microelectronic fabrication, including forming ohmic contacts, forming interconnects for circuits, photolithographic mask repair, device restructuring and customization, and design and fault correction.

Prior art material-additive DWM technologies include inkjet printing, Micropen®, laser chemical vapor deposition (LCVD), focused CVD, laser engineered net shaping (LENS), laser-induced forward transfer (LIFT), and matrix-assisted pulse-laser evaporation (MAPLE). Currently known material-subtractive DWM technologies for removing material from a substrate include laser machining, laser trimming, and laser drilling.

In the “LIFT” process, a pulsed laser beam is directed through a laser-transparent target substrate to strike a film of material coated on the opposite side of the target substrate. The laser vaporizes the film material as the material absorbs the laser radiation. Due to the transfer of momentum, the material is removed from the target substrate and is redeposited on a receiving substrate that is placed in proximity to the target substrate. This “LIFT” process is typically utilized in transferring opaque thin films (typically metals), from a pre-coated laser transparent support (i.e. typically glass, SiO2, Al2O3, etc.), to a receiving substrate. Due to the film material being vaporized by the action of the laser, LIFT is inherently a homogeneous, pyrolytic technique and typically cannot be used to deposit complex crystalline or multi-component materials. Furthermore, because the material to be transferred is vaporized, it becomes more reactive and can more easily become degraded, oxidized or contaminated. The method is not well suited for the transfer of organic materials, since many organic materials are fragile and thermally labile and can be irreversibly damaged during deposition. Other shortcomings of the LIFT technique include poor uniformity, morphology, adhesion, and resolution. Further, in response to the high peak temperatures involved in the process, there is a danger of ablation or sputtering of the support, which can cause the incorporation of impurities in the material that is deposited on the receiving substrate.

A similar technique referred to as the “MAPLE” technique (i.e. as described in U.S. Pat. No. 6,177,151 issued Jan. 23, 2001 to Chrisey, et al.) also involves depositing a transfer material onto a receiving substrate. The front surface of a target substrate has a coating that comprises a mixture of the transfer material to be deposited and a matrix material. The matrix material is a material that has the property that, when it is exposed to pulsed laser energy, it is more volatile than the transfer material. Pulsed laser energy is directed through the back surface of the target substrate and through a laser-transparent support to strike the coating at a defined location with sufficient energy to volatilize the matrix material at the location, causing the coating to desorb from the location and be lifted from the surface of the support. The receiving substrate is positioned in a spaced relation to the target substrate so that the transfer material in the desorbed coating can be deposited at a defined location on the receiving substrate. This technique requires a separate step for the preparation of a coating on a substrate. For some intended transfer materials, it may be difficult to find a suitable matrix material that is physically and chemically compatible with the transfer material so that the “lifting” procedure can be properly carried out.

In general, DWM techniques are not suitable for use as solid freeform techniques for a number of reasons, including but not limited to the following. Many of the techniques, such as LCVD and focused CVD, are designed for the deposition of thin films, not thick films, slowing the layer-addition process. Other techniques, such as LIFT and MAPLE, do not allow for deposition of a support structure in a layer-wise 3-D part-building process. The commercially available systems for carrying out these techniques are not typically configured with a thickness-direction positional device and control.

Accordingly, a need exists for a layer-additive apparatus and method of solid freeform direct-write three-dimensional fabrication. The present invention fulfills that need and overcomes drawbacks of prior systems and methods.

### BRIEF SUMMARY OF THE INVENTION

The objects of the invention are realized by a process and related apparatus for fabricating a device or device components point-by-point, as well as for manufacturing a multi-layer or three-dimensional object point-by-point and layer-by-layer. By way of example and not limitation, the process basically comprises co-deposition of a liquid composition and solid powder particles at predetermined proportions to desired spots on a target surface. A directed energy source, such as a laser beam, is directed at the co-deposition location to provide sufficient energy or intensity to induce a chemical reaction, a physical transition, or a combination thereof to the deposited liquid composition and/or solid powder so that a desired material composition is solidified at these spots. Both liquid droplets and solid powders can be selected from a wide range of materials. The process allows for variations in material compositions from point to point and in a multi-layer device or object from layer to layer, if so desired. The process is executed in an automated fashion under the control of a computer, preferably in response to files generated from a CAD program.

It should be noted that the present process and apparatus are different and distinct from a prior art process and apparatus cited earlier (Jang, et al., U.S. Pat. No. 6,405,095 issued Jun. 11, 2002, incorporated herein by reference. FIG. 1 shows a pneumatic powder-feeder and a laser beam in the prior art SFF apparatus. Solid powders are propelled to strike at a weld pool spot on a target surface. The powder particles striking at this spot become melted by the laser beam and become a part of the weld pool. When the powder feeder and the laser beam move away, this spot of material becomes solidified and continuous “scanning” of this nozzle traces out a desired cross-section of an intended 3-D object. This prior art process has the following characteristics that are distinct from the features of the present invention.

The purpose of using a liquid droplet deposition device within U.S. Pat. No. 6,405,095 is to dispense fine droplets of solidifiable liquid compositions to form a gradient-thickness zone in order to reduce or eliminate the staircase effect near any exterior peripheral zone. Staircase effect is an intrinsic shortcoming of most SFF processes. The liquid droplet deposition system of the U.S. Pat. No. 6,405,095 patent allows depositing on a separate and independent basis, fine metal or ceramic powder to build a major portion of a layer. The droplets of liquid compositions are not mixed with the solid powder (e.g., to form a composite) in any spot of a layer. In contrast, the presently invented process provides for combining a solid powder with a liquid composition, wherein the resultant combination could be prescribed to react to form a product phase different from either reactant.

In the prior art process and apparatus of U.S. Pat. No. 6,405,095, the laser beam is only used to create a weld pool (a pool of molten metal or ceramic) from the solid powder particles. The laser beam does not interact with the dispensed droplets of the liquid compositions. The liquid compositions become solidified upon removal of a solvent or upon cooling to below the melting point of a liquid ingredient. In contrast, the techniques of the present invention permit the laser beam, or another directed energy source, to induce a chemical reaction or physical transition to the liquid composition, powder particles, or mixture of the liquid composition and powder.

In the prior-art process described in U.S. Pat. No. 6,405,095, a pneumatic powder dispensing device is used to feed powder particles into the weld pool. Scattering of powder particles and spreading of metal melt tend to result in a large weld pool size, possibly leading to poor part resolution if not for the complementary function of an inkjet printing process. In contrast, the presently invented apparatus includes an ultrasonic or vibration-based micro-powder feeder, which turns on and off according to the imposed wave intensity or frequency. In a preferred embodiment, no air pressure is used to propel the powder particles and, hence, positioning accuracy of dispensed powder particles can be more accurately controlled.

The present invention also differs from another SFF process disclosed by one of the inventors of the present invention and described in U.S. Pat. No. 6,401,002 issued Jun. 4, 2002, incorporated herein by reference. This SFF process involves the use of selected liquid droplets to bind together powder particles primarily for the purpose of making a multi-color or multi-material object point-by-point and layer-by-layer. It should be appreciated that this previously described SFF technique does not involve the use of a laser beam or other directed energy source for interacting with the deposited solid powder or liquid droplets.

The present invention is amenable to implementation according to a number of different embodiments. One embodiment describes an apparatus for fabricating an object or device, comprising: (a) an object support platform; (b) means for depositing selected liquids and powders in a given proportion on the object support platform; (c) means for directing a sufficient amount of energy to the combination of deposited liquids and powders to induce a state change; and (d) means for generating relative motion between the object support platform and the means for depositing selected liquids and solids to define a three-dimensional object.

The state change preferable comprises solidification of the combination of liquid and solid materials to form either a three-dimensional object structure, or a device such as comprising an electronic component, sensor, or micro-electro-mechanical system (MEMS). The liquids and/or solids are preferably selected from a plurality of liquids and solids adapted for being combined toward fabricating devices and objects with specific physical and electrical characteristics (i.e. color, hardness, flexibility, electrical resistivity, semiconducting properties, and so forth).

Another embodiment of the apparatus for fabricating objects and devices can be described as comprising: (a) an object support platform; (b) a material deposition sub-system comprising, (i) a liquid deposition device, (ii) a powder deposition device, (iii) a directed energy source configured for being directed at the deposited liquid and powders on said object support platform to induce a state change; and (c) a motion device configured for generating relative motion between the object support platform and the material deposition sub-system during the deposition of liquids and solids while fabricating a three-dimensional object.

Another embodiment of the apparatus can be described as comprising: a direct write and solid freeform fabrication apparatus for making a device or a three-dimensional object. The apparatus comprises, in combination, (a) a target surface on an object-supporting platform; (b) a material deposition sub-system disposed a distance to the platform, and (c) motion devices. The material deposition sub-system comprises a liquid deposition device, a powder-dispensing device, and a directed energy source.

The liquid droplet deposition device includes (1) at least a flow channel with the channel being supplied with a liquid composition, (2) at least one nozzle having (on one end) a fluid passage in flow communication with the channel and a discharge orifice of a desired size (on another end), and (3) actuator means (located in control relation to the channel) for activating ejection of liquid composition droplets through the discharge orifice toward selected spots of the target surface.

A powder-dispensing device is disposed a distance from the liquid droplet deposition device. This micro-powder feeder comprises (1) at least a flow channel being supplied with solid powder particles, (2) at least one nozzle having (on one end) a flow passage (in flow communication with the flow channel) and a discharge orifice of a desired size (on another end) to dispense powder particles therethrough toward selected spots of the target surface, and (3) ultrasonic or vibration-based valve means located in control relation to the flow channel. This valve means is such that when a vibration wave frequency or amplitude exceeds a threshold valve, micro powder particles will flow out of a capillarity tube (the “ON” state); otherwise, powder particles will remain in the tube (“OFF” state).

Another embodiment of the apparatus can be generally described as a direct write or freeform fabrication method (process) for making a device or a three-dimensional object. The process generally includes the following steps: (a) providing a target surface on an object-supporting platform; (b) operating a material deposition sub-system comprising a liquid deposition device for dispensing at least a liquid composition and a solid powder-dispensing device for dispensing solid powder particles to selected locations on the target surface; (c) operating a directed energy source for supplying energy to the dispensed liquid composition and dispensed powder particles to induce a chemical reaction or physical transition thereof at these selected locations; and (d) moving the deposition sub-system and the object-supporting platform (during the operating steps (b) and (c)) relative to one another in a plane defined by first and second directions (X- and Y-directions) to form the dispensed liquid composition and dispensed powder particles into the device or object. Preferably, motions are also allowed in the Z-direction perpendicular to the X-Y plane so that a multi-layer device or a 3-D object may be built layer-by-layer.

The liquid droplet deposition device may comprise a device selected from the group consisting of an inkjet print-head, a solenoid valve, a gear pump, an extruder, a positive displacement pump, a piston, a pneumatic pump, a sprayer, and a combination thereof. The liquid droplet deposition device and the powder-dispensing device are preferably positioned in such a manner that the ejected liquid droplets and the dispensed powder particles are deposited at substantially identical spots of the target surface. The liquid droplet deposition device may comprise a plurality of separate liquid dispensing devices or at least a multiple-orifice liquid dispensing device.

The directed energy source (i.e. a laser beam) is used to achieve one or several, in combination, of the following purposes: (1) converting a liquid composition into a solid phase (i.e. UV laser curing of a photo-curable resin or UV induced polymerization of a monomer), (2) decomposing a liquid composition or solid powder into a solid product (i.e. converting an organo-metallic liquid into a metal phase), (3) fusing the solid powder to become a melt which solidifies upon cooling, (4) sintering the solid powder particles, (5) annealing the solid powder particles to induce a phase transition (i.e. from one crystal structure to another), and (6) inducing a chemical reaction between a liquid composition and a solid powder to produce a solidifiable product. Combinations of liquid and solid compositions, under the influence of a directed energy source, make it possible to deposit a wide range of materials onto a target surface. This is a major advantage of the present invention.

If the directed energy source comprises a laser beam, it can also be used to remove a portion of a substrate (e.g., to create a via hole in a printed circuit board) for direct write manufacturing of electronic components, or to trim the edge of a deposited layer in a layer manufacturing process for improved part accuracy.

Another embodiment of the apparatus can be generally described as a method of freeform fabrication of three-dimensional objects and direct writing of devices using spatially tailored material compositions, comprising: (a) creating an image of the device or object on a computer, the image including a plurality of segments or data points defining the object, each of the segments or data points being coded with a specific material composition; (b) evaluating the data files representing the device or object to locate any un-supported feature of the device or object, followed by defining a support structure for the un-supported feature and creating a plurality of segments or data points defining the support structure; (c) generating program signals corresponding to each of the segments or data points for both the device or object and the support structure in a predetermined sequence; (d) dispensing and depositing droplets of liquid compositions and solid powder particles of predetermined material compositions at predetermined proportions onto a target surface of an object-supporting platform and operating a directed energy beam to induce a chemical change or physical transition to the deposited liquid compositions, or powder particles, or both, for forming the device or object and the support structure; and (e) moving the deposition sub-system and the object-supporting platform, during the deposition step, in response to the programmed signals relative to one another in a plane defined by first and second directions and in a third direction orthogonal to the plane in a predetermined sequence of movements such that the material compositions are deposited in free space as a plurality of segments or beads sequentially formed so that the last deposited segment or bead overlies at least a portion of the preceding segment or bead in contact therewith to form the support structure and the multi-material three-dimensional device or object. In addition a directed energy source, such as a laser beam, can be utilized to remove a portion of the deposited liquid composition, or the deposited solid powder, or both, or to remove a portion of a reaction product between the dispensed liquid composition and the dispensed powder particles.

Numerous beneficial aspects are described for the apparatus and methods according to the present invention. These aspects can be implemented singly or in various combination without departing from the teachings of the present invention. No single one of these aspects or combination is solely responsible for the desirable attributes provided according to the invention.

An aspect of the invention is a 3-D freeform fabrication and direct write apparatus and method controlled by a computer in which a variety of materials can be processed and a built-up in a point-by-point and layer-by-layer manner. Another aspect of the invention is the use of a directed energy source which aside from changing the state of materials being built up can be utilized for changing the built up items according to a subtractive mechanism (sculpting).

Another aspect of the invention is the performing of direct write manufacturing (DWM) for fabricating electronic devices and MEMS devices.

Another aspect of the invention provides for building up 3-D objects while varying the material composition dynamically as it is being built.

Another aspect of the invention provides for building up 3-D objects from liquid compositions and solid powders that may be selected from a broad array of materials including various organic and inorganic substances and their composites.

Another aspect of the invention is to provide for 3-D freeform fabrication built up from co-deposited solids and liquids whose state is changed in response to a directed energy source.

Another aspect of the invention is to provide a 3-D freeform fabrication method in which direct write manufacturing and solid freeform fabrication (SFF) can be performed.

Another aspect of the invention is to provide a 3-D freeform fabrication method in which object or devices can be fabricated having a spatially controlled material composition comprising two or more distinct types of material.

Another aspect of the invention is to provide a 3-D freeform fabrication method in which electronic components, such as conductors, resistors, capacitors and inductors of different shapes and sizes can be deposited onto a flat, or arbitrarily shaped, substrate layer of any desired composition.

Another aspect of the invention is a build-up control method which utilizes an adaptive layer-slicing approach and a thickness sensor to allow for in-process correction of any layer thickness variation.

Another object of the present invention is to provide a computer-controlled process and apparatus for producing a multi-element device or a multi-material 3-D object on a layer-by-layer basis.

Another object of this invention is to provide a process and apparatus for building a CAD-defined object or device in which the material composition pattern can be predetermined.

Still another object of this invention is to provide a direct write and layer manufacturing technique that places minimal constraint on the range of materials that can be used in the fabrication of a device or 3-D object.

Further aspects of the invention will be brought out in the following portions of the specification, wherein the detailed description is for the purpose of fully disclosing preferred embodiments of the invention without placing limitations thereon.

### BRIEF DESCRIPTION OF THE SEVERAL VIEWS OF THE DRAWING(S)

The invention will be more fully understood by reference to the following drawings which are for illustrative purposes only:

FIG. 1 is a schematic of a pneumatic powder feeder utilized according to a conventional solid freeform fabrication process.

FIG. 2 is a schematic of an apparatus for direct writing of a device or freeform object fabrication according to an embodiment of the present invention, showing mechanisms for co-dispensing liquids and solids and for directing an energy source to change the state of the deposited material.

FIG. 3A-3B is a flowchart for performing direct writing and freeform fabrication according to an aspect of the present invention, showing build-up data generation, forming of physical layers and final object unification.

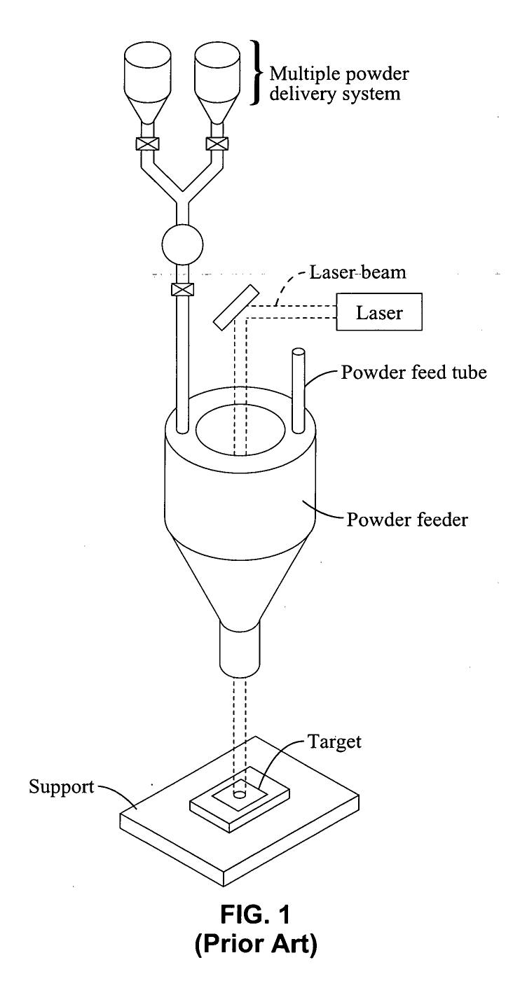

### DETAILED DESCRIPTION OF THE INVENTION

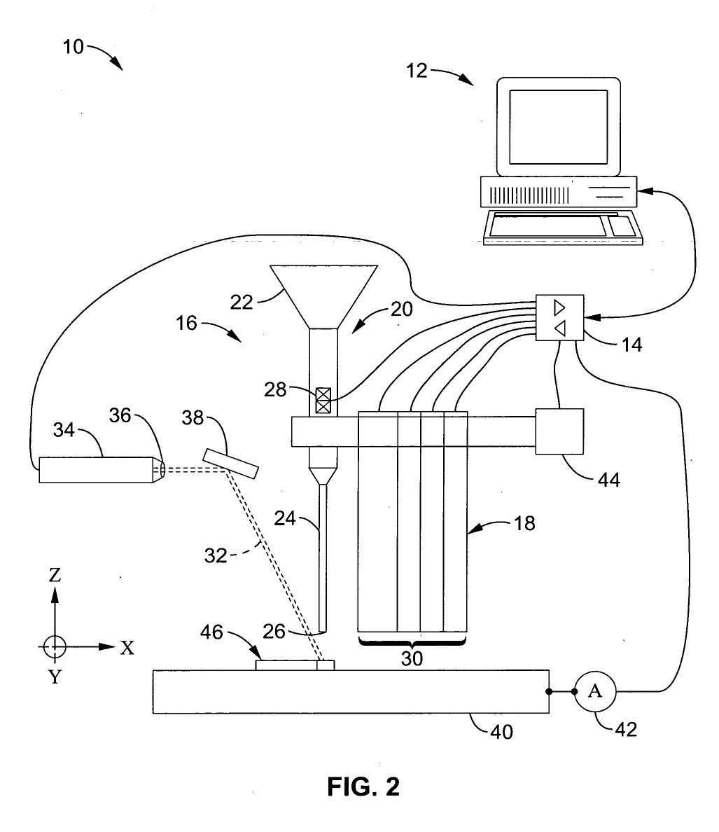

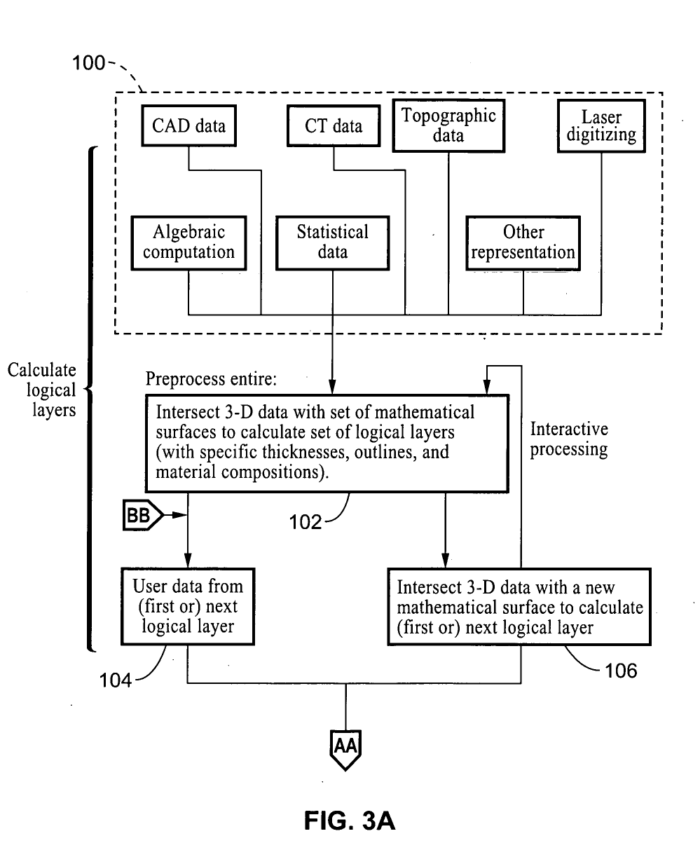

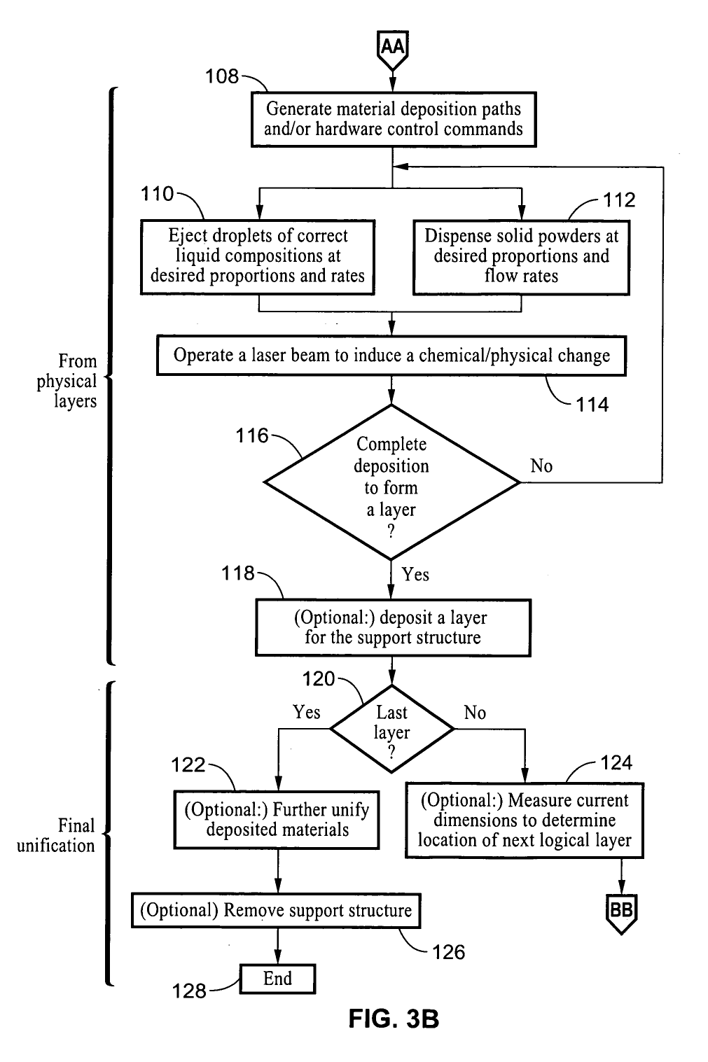

Referring more specifically to the drawings, for illustrative purposes the present invention is embodied in the apparatus generally shown in FIG. 2 through FIG. 3B. It will be appreciated that the apparatus may vary as to configuration and as to details of the parts, and that the method may vary as to the specific steps and sequence, without departing from the basic concepts as disclosed herein.

FIG. 2 illustrates by way of example one embodiment 10 of the direct-writing and freeform 3-D build up apparatus. This apparatus is equipped with a computer 12 for creating a drawing or image (i.e. CAD system) of a device or an object and, through a hardware controller 14 (data acquisition and control head) that monitors and controls the operation of other components of apparatus 10. Hardware controller 14 preferably comprises necessary inputs and outputs for monitoring the process and outputting proper control signals, such as for example comprising a signal generator, amplifier, and other needed functional parts. It should be appreciated that hardware controller 14 may itself comprise a computerized device configured for interacting with a user or interfacing with a separate computer.

One of these components being controlled is a material deposition sub-system 16 which comprises a (preferably multiple-channel) droplet deposition device 18, a powder-dispensing device 20 with hopper 22 and capillary tube 24. More than one hopper may be used to receive two or more types of powders if so desired. Alternatively, a plurality of powder feeders may be combined to provide the capability of supplying and dispensing a mixture of different powders at a desired proportion. The received powder particles flow downward into a capillary tube 24 which has a discharge orifice 26 at the bottom end. A means of controlling the flow of powder is provided, such as a piezo-electric actuator element 28 disposed on or otherwise positioned with reference to the capillary tube to create an ultrasonic wave or vibration of the tube for discharging a controlled rate of material. It has been found that micron- or nano-scaled powder particles can be discharged from the orifice at a controlled rate when the vibration intensity or frequency exceeds a threshold value. This mechanism therefore serves as an ON-OFF valve that can be controlled in real-time by computer 12 through data acquisition and control system 14. Particle size of the powder being dispensed is preferably less than 300 μm, and more preferably less than around 10 μm.

Liquid droplet deposition device 18 may comprise any of numerous liquid droplet deposition devices that can be incorporated herein to provide the desired deposition accuracy and flow rate characteristics. Preferable the deposition device comprises a means for dispensing any of a number of different liquids. One type of preferred deposition device is an inkjet print-head, such as a thermal or piezo-electric head. A thermal inkjet print head operates by selectively using thermal energy produced by resistors located in capillary filled ink channels near channel terminating orifices to vaporize momentarily the ink and form bubbles on demand. Each temporary bubble expels an ink droplet and propels it toward the object platform. Another useful droplet deposition device is a piezoelectric activated inkjet print-head that uses a pulse generator to provide an electric signal. The signal is applied across piezo-electric crystal plates, one of which contracts and the other of which expands, thereby causing the plate assembly to deflect toward a pressure chamber. This deflection causes a decrease in volume which imparts sufficient kinetic energy to the ink in the print-head nozzle so that one ink droplet is ejected through an orifice.

Droplet deposition device 18 may comprise any desired means of dispensing at least one liquid. The droplet size should be smaller than 300 μm, more preferably less than about 100 μm, and most preferably less than 10 μm or even less than 1 μm. It will be appreciated that arbitrarily small droplet sizes may be utilized. The viscosity of the liquid is preferably less than 10,000 centi-Poise (cPs), and more preferably less than 100 cPs. In one embodiment of the invention, droplet deposition device 18 comprises a planar high-density array 30 of drop-on-demand inkjet print-heads typically formed with a print-head body and a multiplicity of parallel ink channels. The channels contain liquid compositions and terminate at corresponding ends thereof in a nozzle plate in which are formed orifices. Ink droplets are ejected on demand from the channels and deposited on selected spots of a target surface, which could be a previous layer of an object or a surface of the object platform.

In an alternative embodiment of the presently invented apparatus, the liquid deposition device may comprise a plurality of separate droplet deposition devices, each having a limited number of channels, such as only one or two channels. Preferably, in a SFF process, one of the channels is used to deposit a material such as wax or water-soluble polymer for building the necessary support structure.

It should be appreciated that a number of metering and dispensing nozzles capable of depositing wax and various resins, such as epoxy and polyurethane, are commercially available. Examples include various two-component dispensing devices such as PosiDotR™ from Liquid Control Corporation™ in North Canton, Ohio and Series 1125 Meter-Mix-Dispense systems from Ashby-Cross Company™ in Topsfield, Mass. It will be appreciated that any dispensing nozzle suitable to the material being dispensed, accuracy, and flow rate may be incorporated within the present apparatus to deposit a resin- or wax-based support structure when and where needed.

Preferably, a portion of the liquid deposition device is provided with temperature-controlled means (not shown) to ensure that the material remains in a flowable state while residing in a reservoir, pipe, or channel prior to being dispensed.

The dispensing ratio of liquid volume to powder volume is controlled by the computer which controls dispensing, from 0/100 to 100/0, while more typically ratios will be in the 30/70 to 70/30 percentile ratio range. The deposition is performed sequentially, or more preferably simultaneously.

A directed energy source is depicted as a laser beam 32 generated from laser 34 passing through optics 36, 38, exemplified as a combination of a lens 36 and a reflector 38. The directed energy source may be selected from the group consisting of a laser beam, infrared, ultra-violet light, electron beam, ion beam, X-radiation, Gamma ray, plasma, as well as other sources of energy capable of changing the state of deposited materials, or a combination of those energy sources may be utilized. The directed energy source is preferably of sufficient intensity or desired frequency or range of frequencies if comprising electromagnetic waves, to induce a physical or chemical change in the dispensed liquid droplets, powder particles, or a mixture of a liquid composition and a solid powder to generate a solidified or consolidated product. The laser is preferably in the wavelength range of from less than 300 nm (UV) or greater than 750 nm (IR) for curing materials, or of other wavelength that generates a desired reaction with the deposited constituents either separately, or more preferably in combination. The laser preferably comprises a high power (i.e. on the order of 200 W) solid-state laser, gas-discharge laser or the like, preferably having a tight focus on the order of from 10-200 μm. The laser may be pulsed or provide a continuous wave output. One preferred laser is a Nd:YAG laser if melting and sintering are to be performed. A preferred directed energy source 32 comprises a laser beam 34, beam-focusing means 36 (i.e. laser optics), and beam-directing means 38. Preferably a beam controller is integrated within laser 34 to allow the computer 12, such as through control head 14, to regulate the intensity, frequency, direction, size, and/or focusing of laser beam 32.

An object-support platform 40 is shown having position control actuator 42. It should be appreciated that the positioning of the liquid and/or powder deposition system can be additionally controlled, such as utilizing a three-axis motion device 44 controlled by control head 14. A device or object 46 is shown being fabricated on platform 40. It will be appreciated that the system may also deposit devices or build up three dimensional objects on substrates, or combinations of objects, which are preferably retained upon platform 40. The combination of platform and actuator form a three dimensional movement system to direct the application of solids and liquids as well as the application of a desired source of energy. The material deposition sub-system is thus controlled in relation to an X-Y plane and in a Z-direction as defined by the rectangular coordinate system (optionally other coordinate systems may be utilized such as polar coordinates, as-will be recognized by one of ordinary skill in the art).

The top surface of object platform 40 is preferably located in close, working proximity to the liquid and solid dispensing nozzles of the material deposition sub-system. In the case of solid freeform fabrication, the upper surface of the platform preferably has a flat region (a target surface) of sufficient area to accommodate the first few layers of the deposited material. For use in a direct write manufacturing apparatus, the platform supports a silicon or plastic substrate, of which the top surface may be used as a target surface to receive dispensed liquid droplets and powder particles.

The platform can include an optional temperature-regulating means (not shown) and pump means (not shown) to control the atmosphere of a zone surrounding the platform (if so desired). Heating and cooling means (i.e. heating elements, cooling coils, thermocouple, and temperature controller; not shown) may be provided to a region surrounding platform 40 to control the solidification behavior of the material on the platform.

Preferably, the liquid deposition device 18 and solid powder dispensing device 20 of the material deposition sub-system are fastened to move as one unit. The laser beam source and laser optics may be attached to this same unit or be positioned separately. In the latter case, the positions and angles of laser deflecting and focusing lenses are preferably adjustable in such a manner that the laser beam may be focused on any spot in an X-Y plane. Platform 40 and the material deposition sub-system 16 equipped with mechanical drive means for moving the platform relative to the deposition device in three dimensions along the X-, Y-, and Z-axes in a rectangular coordinate system in a predetermined sequence and pattern, and for displacing the nozzle a predetermined incremental distance relative to the platform. This can be accomplished, for instance, by allowing the platform 40 to be driven by three linear motion devices, which are powered by three stepper motors to provide movements along the X-, Y-, and Z- directions, respectively. Motor means are preferably high resolution reversible stepper motors, although other types of drive motors may be used, including linear motors, servomotors, synchronous motors, D.C. motors, piezo-electric motors, and fluid motors. Mechanical drive means including linear motion devices, motors, and gantry type positioning stages are well known in the art.

Movement in the Z-axis can be executed to displace platform 40 relative to the material deposition sub-system or to displace the deposition sub-system relative to the platform and, hence, relative to each layer deposited prior to the start of the formation of each successive layer. In one possible arrangement, the deposition sub-system may be mounted in a known fashion for movement in the X-Y plane, with the platform 16 supported for separate movement toward and away from the deposition sub-system along the Z-direction. Alternatively, the platform may be supported for movement in the X-Y plane, with the deposition sub-system mounted for separate movement along the Z-direction toward and away from the platform. Another alternative is to have the movements in the X-Y plane and in the Z-direction all to be carried out-by either the platform only or by the deposition sub-system only. It will be understood that movement in the X-Y plane need not be limited to movement in orthogonal directions, but may include movement in radial, tangential, arcuate and other directions in the X-Y plane.

These movements will make it possible for the deposition sub-system to deposit and form multiple layers of materials of predetermined thickness, which build up on one another sequentially as the material solidifies after discharge from the orifice. The rate at which the droplets are discharged from the discharge orifice onto the platform is dictated by the frequency of the piezo-electric pulses and the orifice size. This rate can be adjusted, by varying the pulse signal generating speed, to meet the possible needs of the variable rate at which the nozzle moves with respect to the platform. The powder deposition rate depends upon the valve opening sizes and the ultrasonic or vibration wave intensity and frequency.

Sensor means (not shown) may be attached to proper locations on the object platform 40 or the material deposition sub-system 16 to monitor the physical dimensions of the physical layers being deposited. The data obtained can then be fed back, preferably through control head 14, to the computer for periodically re-calculating new layer data. This option provides an opportunity to detect and rectify potential layer variations; such errors may otherwise accumulate during the build process, leading to significant part inaccuracy. Many prior art dimension sensors may be selected for use in the present apparatus.

The liquid compositions to be dispensed from the liquid dispensing means 18 do not have to be in a melt state. By way of example, a water-soluble material such as poly (ethylene oxide) may be allowed to mix with a predetermined amount of water to form a flowable solution or paste. Some materials (i.e. plaster and starch) may be dispersed, but not completely dissolved, in water or another type of non-toxic liquid. These types of materials may also be fed into the reservoirs along with water or a proper liquid to make a paste.. The fluid may also be mixed with a selected functional ingredient (i.e. colorant, pigment, anti-oxidant, flame-retardant, catalyst, co-catalyst, polymerization initiator, curing agent, filler, reinforcement, and so forth, preferably in a liquid or fine powder form) to form an ejectable liquid composition.

The discharged fluid and the dispensed powder particles that contact the object platform or a previous layer must meet two conditions. The first condition is that these materials, alone or in combinations (before or after material-laser interaction), must have a sufficiently high viscosity to prevent excessive flow when being deposited; this is required in order to achieve good dimensional accuracy. The second condition is that the newly discharged material must be able to adhere to a previous layer. These two conditions can be met by discharging the materials, such as the following types, under a specified condition.

In order to be used as a “liquid composition” as defined in the present patent, a ceramic, metallic, wax, or semi-crystalline polymer material must be maintained at a temperature above its melting point just before being dispensed or ejected as liquid droplets. The target surface on the object platform (a substrate for a device or a previously deposited layer) must be maintained at a temperature lower than the melting temperature of the ejected droplets. The portion of the previous layer facing the deposition device must have been solidified before the new material is brought in contact with this portion of the previous layer. In order to be used as a “solid powder” in the present invention, a ceramic, glass, metal, carbon, or polymer material is preferably composed in a fine powder form with particle sizes smaller than 10 μm, more preferably smaller than 1 μm, and most preferably smaller than 0.1 μm (in the nanometer range).

According to one aspect of the invention a “liquid composition”, a non-crystalline material such as glass (i.e. boro-silicate glass and soda-lime-silica glass) and amorphous thermoplastic polymer material must be maintained at a temperature slightly above its glass transition temperature just before being discharged. The object platform and the previous layers must be maintained at a temperature lower than its glass transition temperature. The portion of the previous layer facing the nozzle must have been solidified before the new material is brought in contact with this portion of the previous layer. Examples of substantially amorphous thermoplastic polymers are polystyrene (PS), acrylon itrile-butadiene-styrene copolymer (ABS), polymethyl methacrylate (PMMA), and polycarbonate (PC).

In one aspect of the invention a “solid powder” can comprise a glassy or amorphous material (or any material to be fed into a powder-dispensing device) which is preferably in a fine powder form with the average particle size preferably smaller than 10 μm, further preferably smaller than 1 μm, and most preferably smaller than 0.1 μm (in the nanometer range).

For use as a “liquid composition”, a liquid-soluble material (i.e., water soluble polymer) is preferably maintained at a solution state with a high solute content (low percentage of liquid). The object platform and the previously deposited layers are preferably be maintained at a temperature lower than (preferably much lower than) the freezing temperature of the liquid so that the new material when brought in contact with a previous layer is rapidly solidified. Upon completion of the object-building procedure, the solidified object is subjected to a high vacuum environment, such as created by a vacuum pump, to promote sublimation of the “solvent” component (i.e. the “liquid” component now in its solid state). This is essentially a freeze-drying procedure well known in the food processing industry. Upon completion of this freeze-drying procedure, the object will be highly porous and may be impregnated with a material such as a wax or epoxy resin for improved integrity. This type of material is particularly useful for solid freeform fabrication, while it is not generally utilized in direct write manufacturing.

For use as a “liquid composition”, a solid material (i.e. fine ceramic, metallic, polymeric powder, and so forth) can be dispersed (mixed but not dissolved) in a liquid and made into a paste of proper viscosity. The particle sizes are preferably as small as possible, preferably smaller than 10 μm and preferably smaller than 1 μm in diameter, to prevent clogging of the ejection orifice in the liquid droplet deposition device. Preferably, the liquid comprises a fast vaporizing liquid such as ethanol, methanol, and acetone; a non-toxic material (i.e. alcohol) having a high vapor pressure at room temperature is most desirable. The part-building zone surrounding the object platform is preferably subject to a vacuum to facilitate vaporization of the liquid, rapidly leaving behind the solid. A lower temperature environment may be desired for reduced flowability of the paste. Alternatively, a freeze-drying procedure may be followed to remove the liquid component.

A fast-curing thermosetting resin (i.e. a two-part epoxy) may be maintained in an oligomer state prior to being discharged. Upon being dispensed, the resin rapidly gels to an extent that the glass transition temperature of this reacting resin quickly approaches or exceeds the object platform environment temperature, thereby solidifying the resin. The gelation process of selected resins, such as some photo curable epoxy resins commonly used in stereo lithography, may be further accelerated by exposing the deposited resin to an energy source, such as an ultraviolet beam (i.e. less than approximately 300 nm wavelength range), infrared beam (i.e. greater than approximately 750 nm wavelength range) or other beam configured to change the state of the material. Fast curing resins are well known in the art and several formulations are commercially available.

A fast curing resin may be discharged onto the same spots as those dispensed powder particles so that the resin can hold and bond the particles in place to maintain the spot shape, dimension, and integrity for improved part or device accuracy. On the other hand, if a “liquid composition” is too thin (with an excessively low viscosity), mixing of this resin with solid particles will effectively thicken the resin (before the resin is solidified, cured, or hardened) for improved part or device accuracy. A combination of a liquid composition and a solid powder may be utilized as a reactant pair. This is especially true when the liquid material is in a liquid state at ambient temperature while the solid is in a fine powder form under ambient conditions. This pair of deposited materials, with the assistance from a directed energy source, may undergo a chemical reaction to generate a desired product phase, which is solidified or consolidated to become a useful component on a device substrate. Many materials are available in liquid form and many others in powder form. This combination of a liquid dispensing device, a fine powder feeder, and a directed energy source makes the present invention a highly versatile and powerful direct write and freeform fabrication technique.

A sol-gel or colloidal material (i.e. a polymer gel composed of a lightly cross-linked network of chains with small molecules occupying interstices between these chains or nanometer-scaled oxide particles dispersed in a solvent) can be formulated to have proper flowability prior to being discharged from a nozzle. The gelation process of the material when brought in contact with the object platform or a previous layer may be rapidly advanced further to increase its viscosity to facilitate solidification.

The target surface in a direct write apparatus may be a device substrate that can be any material, planar or non-planar, onto which one may wish to deposit a liquid composition and a powder material. The device substrate may be any solid material including, but not limited to, silicon, glass, plastics, metals, and ceramics. The present invention is particularly useful in creating electronic devices such as passive and active components of printed circuit boards (PCBs) or in creating chemo-selective coatings for chemical sensors such as surface acoustic wave (SAW) resonators.

According to the specific application, material selected for direct write device manufacturing (DWM) can comprise any desired material, including, but not limited to the following:

(A) Metals, including, but not limited to silver, nickel, gold, copper, chromium, titanium, aluminum, platinum, palladium, and so forth as well as alloys thereof. These materials are particularly useful for fabricating interconnects or conductor elements;

(B) Ceramics, including, but not limited to alumina (Al₂O₃), silica and other glasses, which are good for insulator elements;

(C) Dielectrics, including, but not limited to alumina, magnesium oxide (MgO), yttrium oxide (Y₂O₃), zirconium oxide (ZrO₂), cerium oxide (CeO₂), and so forth which are suitable for fabricating insulator regions or capacitor elements;

(D) Ferroelectrics, including, but not limited to barium titanate (BaTiO₃), strontium titanate (SrTiO₃), lead titanate (PbTiO₃), lead zirconate (PbZrO₃), potassium niobate (KNbO₃), strontium bismuth tantalate (SrBi₂Ta₂O₉), (Ba,Sr)TiO₃, and solid solution stoichiometric variations thereof and so forth, which are useful for sensor and capacitor elements;

(E) Piezoelectrics, including, but not limited to the above mentioned ferroelectrics, quartz, AlN, etc., which are useful for sensor and actuator applications (i.e. surface acoustic wave device);

(F) Ferrites, including but not limited to yttrium iron garnet (Y₃ Fe₅O₁₂), barium zinc ferrite (Ba₂Zn₂Fe₁₂O₁₉), hexagonal ferrites such as barium ferrite, spinel ferrites such as nickel zinc ferrites, manganese zinc ferrite, magnetite (Fe₃O₄), etc., which are useful for magnetic elements;

(G) Electro-optical ceramics, including, but not limited to lithium niobate (LiNbO₃), lithium tantalate (LiTaO₃), cadmium telluride (CdTe), zinc sulfide (ZnS), etc., which are useful for electro-optic device elements such as light-emitting diodes and flat panel display substrates;

(H) Ceramic superconductors, including, but not limited to YBa₂Cu₃O₇-x (YBCO), Tl₂CaBa₂Cu₃O₁₂, La1.4Sr0.6CuO₃, BiSrCACuO, BaKBiO, halide doped fullerines, etc.;

(I) Chalcogenides, including, but not limited to SrS, ZnS, CaS, PbS, etc., which are useful as energy conversion elements such as solar cells;

(J) Semiconductors, including, but not limited to Si, Ge, GaAs, CdTe, etc.;

(K) Phosphors, including, but not limited to SrS:Eu, SrS:Ce, ZnS:Ag, Y2O₂:Eu, Zn₂SiO₄:Mn, etc. and transparent conductive oxides, including, but not limited to indium tin oxide, zinc oxide, etc.; and

(L) Bio- and chemical sensing elements.

If the target surface (substrate) is a component of an electronic device, the materials to be deposited should have particular desired electronic properties. Examples of electronic materials include metals, dielectrics, ferroelectrics, ferrites, ferrimagnets, ferromagnets, semiconductors, phosphors and electrically conducting organic polymers.

If the target substrate is a component of a chemical or biological sensor, the materials to be deposited should be chosen for selective interaction with a particular chemical or biological analyte. It is well known in the art that the chemically selective material may be a polymer with hydrogen bond acidic properties, a polymer with hydrogen bond basic properties, a dipolar polymer, a polarizable polymer, or a non-polar polymer, depending on the characteristics of the analyte of interest. Examples of chemo-sensing element materials include SXFA (poly(oxy{methyl[4-hydroxy-4,4,bis(trifluoromethyl)but-1-en-1-yl]silylene})), P4V (poly(4-vinylhexafluorocumyl alcohol). Other examples include perfluoro-polyethers terminated with a variety of functional groups such as CF₃, CH₂OH, polyethylene imines, polysiloxanes, alkylamino pyridyl substituted polysiloxanes, polytetrafluoroethylene, polysilanes, polyesters, polyvinylaldehydes, polyisobutylene, polyvinylesters, polyalkenes, zeolites, aerogels, porous carbon, metals, silicalites, clay materials, cellulose materials, polyanilines, polythiophenes, polypyrroles, fullerenes, cyclodextrins, cyclophanes, calixeranes, crown ethers, and organic dyes.

Examples of biochemical species that can be deposited with the present direct write technology include proteins, oligopeptides, polypeptides, whole cells, biological tissue, enzymes, cofactors, nucleic acids, DNA, RNA, antibodies (intact primary,-polyclonal, and monoclonal), antigens, oligosaccharides, polysaccharides, oligonucleotides, lectins, biotin, streptavidin, and lipids.

The target substrate may be a component of a physical sensing device, such as a magnetic sensor, optical sensor, temperature sensor, pressure sensor, gas flow sensor, and the like. The material to be deposited may then be an appropriate sensing material, such as a magnetic sensing material, optical sensing material, temperature sensing material, pressure sensing material, gas flow sensing material, and so forth. Examples of physical sensing materials to be deposited include materials that make up individual layers of magnetic-nonmagnetic multi-layers or resonant magnetic oscillators for magnetic sensing, thin film thermocouples for temperature sensing, piezo-electric films or resonators for pressure sensing and simple resistive heater-thermocouple combinations for gas flow sensing.

FIG. 3A and FIG. 3B illustrate by way of example an embodiment of the direct write manufacturing or solid freeform fabrication process in which the execution of various steps is shown. First the process of FIG. 3A and FIG. 3B will be summarized and then elements therein discussed in greater detail.

Referring first to FIG. 3A, the data for the object or device is created as represented by block 100. The data is then mathematically preprocessed starting at block 102 to calculate the logical layers with specific thicknesses, outlines and material compositions. User data from the (first) or next logical layer is then selected as per block 104 or an interactive process entered with block 106 for intersecting with a new mathematical surface. This completes the logical layer processing.

The physical layer processing commences in FIG. 3B with block 108 in which material deposition paths are generated, or hardware control commands are directly created, or both. The material deposition system then regulates the ejection of droplets of liquid composition or powder solids in the desired proportions or flow rates as seen in blocks 110, 112. A directed energy source, such as a laser, is operated according to block 114 to induce a change of state in the liquid, or solid, or more preferably co-located combination of liquid and solid material. Unless the entire layer has been completed, as detected at block 116, then dispensing mode continues back at blocks 110, 112. Once the layer is completed, then an optional support step is executed as given by block 118, such as by controlling the depositing of a support material, for example liquid-powder mixtures, wax, and so forth.

If the last layer has not yet been deposited, as detected by block 120, then an optional measurement process 124 can be performed prior to depositing another layer commencing at block 104. The measurement provides feedback to assure that the build is proceeding according to the specification and allow for point-by-point, or layer-by-layer deposition corrections to be applied. Once the last layer is deposited then an optional process of block 122 can commence to unify the deposited materials. An optional step can then be executed as per block 126 of removing the support structure before ending the fabrication process at block 128.

The following addresses a number of these areas in greater detail. The process begins with the creation of a mathematical model and the calculation of logical layers. This object model is stored as a set of numerical representations of layers which, together, represent the whole device or object. A series of data packages, each data package corresponding to the physical dimensions of an individual layer of selected materials, is stored in the memory of a computer in a logical sequence so that the data packages correspond to individual layers of the materials stacked together to form the device or object.

Specifically, in the case of SFF, before the constituent layers of a 3-D object are formed, the geometry of this object is logically divided into a sequence of mutually adjacent theoretical layers, with each theoretical layer defined by a thickness and a set of closed, non-intersecting curves lying in a smooth two-dimensional (2-D) surface. These theoretical layers, which exist only as data packages in the memory of the computer, are referred to as “logical layers.” This set of curves forms the “contour” of a logical layer or “cross section”. In the simplest situations, each 2-D logical layer is a plane so that each layer is flat, and the thickness is the same throughout any particular layer. However, this is not necessarily so in every case, as a layer may have any desired curvature and the thickness of a layer may be a function of position within its two-dimensional surface. The only constraint on the curvature and thickness function of the logical layers is that the sequence of layers must be logically adjacent. Therefore, in considering two layers that come one after the other in the sequence, the mutually abutting surfaces of the two layers must contact each other at every point, except at such points of one layer where the corresponding point of the other layer is void of material as specified in the object model.

As summarized in the top portion of FIG. 3A, the data packages for the logical layers within block 100 may be created by any of a number of methods including the following:

(1) for a 3-D computer-aided design (CAD) model, by logically “slicing” the data representing the model (no slicing is necessary for the case of a single-layer device);

(2) for topographic data, by directly representing the contours of the terrain;

(3) for a geometrical model, by representing successive curves which solve “z=constant” for the desired geometry in an x-y-z rectangular coordinate system; and

(4) other methods appropriate to data obtained by computer tomography (CT), magnetic resonance imaging (MRI), satellite reconnaissance, laser digitizing, line ranging, or other methods of obtaining a computerized representation of a 3-D object.

An alternative to calculating all of the logical layers in advance is to use sensor means to periodically measure the dimensions of the growing object as new layers are formed, and to use the acquired data to help in the determination of where each new logical layer of the object should be, and possibly what the curvature and thickness of each new layer should be. This approach, called “adaptive layer slicing”, is capable of producing more accurate final dimensions for the fabricated object because the actual thickness of a sequence of stacked layers may be different from the simple sum of the intended thicknesses of the individual layers.

The closed, non-intersecting curves that are part of the representation of each layer unambiguously divide a smooth two-dimensional surface into two distinct regions. In the present context, a “region” does not necessarily mean a single connected area. Each region may consist of several island-like subregions that do not touch each other. One of these regions is the intersection of the surface with the desired 3-D object, and is called the “positive region” of the layer. The other region is the portion of the surface that does not intersect the desired object, and is called the “negative region.” The curves are the boundary between the positive and negative regions, and are called the “outline” of the layer. In the present context, the liquid droplets and solid powder are allowed to be deposited in the “positive region” while a wax may be deposited in certain parts or all of the “negative region” in each layer to serve as a support structure.

A preferred embodiment of the present invention contains a material deposition sub-system, an object platform, and motion devices that are regulated by a computer-aided design (CAD) computer and a machine controller. By way of example, the application programming on the CAD computer creates a three-dimensional image of a desired object or device and converts the image into multiple sets of elevation layer data, each layer being composed of a plurality of segments (or vectors), data points, or a combination thereof.

As a specific example, the image of a three-dimensional object may be converted into a proper format utilizing commercially available CAD/Solid Modeling software. A commonly used SFF format is the stereo lithography file (.STL), which has become a defacto industry standard for rapid prototyping. For direct write manufacturing, the circuit design of a device could, for example, make use of the DXF format, or other convention. The object image data may be sectioned into multiple layers by a commercially available software program, with each layer having its own shape and dimensions. These layers, each being composed of a plurality of segments, when combined together, will reproduce the complete shape of the intended object. When a multi-material object or multi-component device is desired, these segments are preferably sorted in accordance with their material compositions. This can be accomplished by performing the following procedure:

By way of example and not limitation, when the stereo lithography (.STL) format is utilized, the image is represented by a large number of triangular facets that are connected to simulate the exterior and interior surfaces of the object. The triangles may be so chosen that each triangle covers one and only one material composition. In a conventional .STL file, each triangular facet is represented by three vertex points each having three coordinate points, (x1, y1, z1), (x2, y2, z2), and (x3, y3, z3), and a unit normal vector (i, j, k). Each facet is now further endowed with a material composition code. During the slicing step, neighboring data points with the same material composition code on the same layer may be sorted together.

This segment data is then converted into programmed signals (data for selecting deposition tools and tool paths) in a proper format, such as the standard NC G-codes commonly used in computerized numerical control (CNC) machinery industry. These layering data signals may be directed to a machine controller which selectively actuates the motors for moving the deposition sub-system with respect to the object-supporting platform, activates signal generators, drives the valve means in the powder dispensing device, drives the optional vacuum pump means, and operates optional temperature controllers. It should be noted that although .STL file format has been emphasized in this paragraph, many other file formats have been employed in different commercial rapid prototyping and manufacturing systems. These file formats may be used in the presently invented system and each of the constituent segments for the object image may be assigned a material composition code. For instance, Virtual Reality Modeling Language (VRML) format, is known to contain rich material composition and color codes.

The three-dimensional motion controller is electronically linked to the mechanical drive means and is operative to actuate the mechanical drive means in response to “X,” “Y,” and “Z” axis drive signals for each layer received from the CAD computer. It should be recognized that controllers capable of driving motion devices (i.e. linear motor controllers) are readily available, such as those commonly utilized in controlling a milling machine.

Numerous software programs have become available that are capable of performing the presently specified logical layer decomposition functions. Suppliers of CAD/Solid Modeling software packages for converting CAD drawings into .STL format include Structural Dynamics Research Corp.™ (SDRC) of Milford Ohio; Cimatron Technologies™ of Burlington Ontario in Canada; Parametric Technology Corp.™ of Waltham Mass.; and Solid Works™ of Concord Mass. Optional software packages may be utilized to check and repair .STL files which are often subject to gaps, defects, and other format problems. The application AUTOLISP™ can be used to convert AUTOCAD™ drawings into multiple layers of specific patterns and dimensions.

Several software packages specifically written for rapid prototyping have become commercially available. Examples of these include (1) SOLIDVIEW RP/MASTER™ software from Solid Concepts, Incorporated™ of Valencia Calif.; (2) MAGICS RP™ software from Materialize Incorporated™ of Belgium; and (3) RAPID PROTOTYPING MODULE™ (RPM) software from lmageware™ of Ann Arbor Mich. These packages are capable of accepting, checking, repairing, displaying, and slicing .STL files for use in a solid freeform fabrication system. MAGICS RP is also capable of performing layer slicing and converting object data into directly useful formats such as Common Layer Interface (CLI). A CLI file normally comprises many “polylines” with each polyline comprising an ordered collection of numerous line segments. These and other software packages (i.e. Bridgeworks™ from Solid Concepts Incorporated™) are also available for identifying un-supported features in the object and for generating data files that can be used to build a support structure for the un-supported feature elements. The support structures may be built by a separate fabrication tool or by the same deposition device that is used to build the object.

A company named Capture Geometry Inside™ (CGI) of Minneapolis Minn. provides capabilities of digitizing complete geometry of a three-dimensional object. Digitized data may also be obtained from computed tomography (CT) and magnetic resonance imaging (MRI), or similar digitizing techniques known in the art. In one instance the digitized data may be re-constructed to form a 3-D model on the computer and then converted to .STL files. Available software packages for computer-aided machining include NC Polaris™, Smartcam™, Mastercam™, and EUCLID MACHINIST™ from MATRA Datavision™ of Andover Mass.

The physical layers are formed as the preprocessed data is executed point-by-point and/or layer-by-layer in the manufacturing system. The data packages are stored in the memory of a computer, which controls the operation of an automated fabrication apparatus comprising a material deposition subsystem, an object platform, and motion devices. Using these data packages, the computer controls the automated fabrication apparatus to manipulate the fabrication materials (liquid compositions and powder particles) to form individual layers of materials in accordance with the specifications of an individual data package. The liquid material compositions used to form the layer contours preferably have the property that they can be readily solidified and consolidated layer-by-layer. In one embodiment of the invention, the liquid compositions and their mixtures with solid powder particles preferably have the further property that the contours of the fabrication materials when brought into contact with one another bond to each other thereby readily unifying the individual layers.

It is not required that the fabrication materials be homogeneous. These material may, for example, exhibit variations in composition based upon the structural or physical requirements of the desired object being built. These variations may serve to accomplish internal variations of the physical properties of the object, such as hardness, mass density, and coefficient of thermal expansion and variations of external appearance such as color patterns. Another case in which the deposited materials may be in-homogeneous would be one in which the materials consist of a stratum of a primary material and a stratum of adhesive material. In this example, the primary material would provide the gross physical characteristics of the object, while the adhesive would generally provide bonding between the layers, although the adhesive can also contribute to the overall characteristics. In one preferred embodiment, the powder particles may be deposited to comprise a spatially controlled material composition comprising two or more distinct types of materials.

In a further specific embodiment, the powder particles may be deposited in continuously varying concentrations of distinct types of materials. These material composition variations can be readily accomplished by operating the presently discussed powder-dispensing device.

If compositional variation of deposited materials is desired within any particular layer, and if the mechanism for depositing the fabrication material has the capability of depositing the required various compositions automatically, then the variation in composition may be represented mathematically within the data package for each layer, and the mathematical representation may be used to control the composition of materials deposited. However, if the mechanism for depositing a material is limited to providing layers of any one specific composition at a time, then variations in composition may be accomplished by logically separating a particular layer into sub-layers, where each sub-layer is composed of a different material, and the union of the sub-layers is equal to the particular layer. Each sub-layer is then treated as a distinct layer in the deposition process, and the complete layer is formed by the formation and bonding of a succession of its constituent sub-layers. If the interface between sub-layers is along surfaces perpendicular to the layers, and not along surfaces parallel to the layers, then the bonding of each sub-layer is not to the previous sub-layer, but to the previous complete layer.

In view of the foregoing, another embodiment of the present invention provides a direct write or solid freeform fabrication process that can comprise the steps of:
(a) providing a target surface on an object-supporting platform;
(b) operating a material deposition sub-system comprising a liquid deposition device for dispensing at least a liquid composition and a solid powder-dispensing device for dispensing solid powder particles to selected locations on the target surface;
(c) operating a directed energy source for supplying energy to the dispensed liquid composition and the dispensed powder particles to induce a chemical reaction or physical transition thereof at the selected locations; and
(d) during the operating steps (b) and (c), moving the deposition sub-system and the object-supporting platform relative to one another in a plane defined by first and second directions (X- and Y-directions) to form the dispensed liquid composition and the dispensed powder particles, in combination, into the device or object.

A preferred embodiment is a process as set forth in the above four steps, wherein the moving step includes the steps of (i) moving the material deposition sub-system and the platform relative to one another in a direction parallel to the X-Y plane to form a first layer of the materials on the object platform; (ii) moving the deposition sub-system and the platform away from each other by a predetermined layer thickness; and (iii) after the portion of the first layer adjacent to a nozzle of the material deposition sub-system has solidified, dispensing a second layer of the materials (liquid droplets and powder particles) onto the first layer while simultaneously moving the platform and the deposition sub-system relative to one another in a direction parallel to the X-Y plane, whereby the second layer solidifies and adheres to the first layer.

A further preferred embodiment is a process as set forth in the above four steps, (a) through (d) plus (i), (ii) and (iii), further comprising additional steps of forming multiple layers of the materials on top of one another by repeated dispensing of droplets and powder from the deposition device and operating a directed energy source to induce a chemical reaction or physical transition to the dispensed materials as the platform and the deposition sub-system are moved relative to one another in a direction parallel to the X-Y plane, with the deposition sub-system and the platform being moved away from one another in the Z-direction by a predetermined layer thickness after each preceding layer has been formed, and with the dispensing of each successive layer being controlled to take place after the material in the preceding layer immediately adjacent the nozzle has substantially solidified. These steps can be accomplished by operating the apparatus described above either manually or, preferably, under the control of a computer system.

Another preferred embodiment is a process as set forth in the above steps, (a) through (d) plus (i), (ii) and (iii), further comprising the steps of (iv) creating an image of the three-dimensional object on a computer with the image including a plurality of segments or data points defining the object; (v) generating programmed signals corresponding to each of these segments or data points in a predetermined sequence; and (vi) moving the deposition sub-system and the platform relative to one another in response to the programmed signals. It should be appreciated that these additional steps provide computerized control over the relative motions between the deposition sub-system and the platform when building a 3-D object. However, the material composition pattern of an object is not necessarily predetermined, although typically this would be the case. The adjustments of material compositions for different portions of an object can be made at any time during the object building process or in a random fashion, if so desired.

If a predetermined material composition pattern is desired before the object or device building process begins, then this pattern may be defined by attaching a material composition code to each of the constituent segments or data points defining the object or device. When the computer reads a specific code during the fabrication process it sends out proper control signals to select the correct channels for ejecting droplets and powder of selected compositions at desired proportions. Therefore, another embodiment of the present invention is a process as set forth in the above four steps, (a) through (d), but further comprising the steps of (e) creating an image of the object on a computer with the image including a plurality of segments or data points defining the object and with each of the segments being coded with a material composition defined by the operation of a specific set of selected channels; (f) generating programmed signals corresponding to each of these segments or data points in a predetermined sequence; (g) operating the pulse generator (actuator means) in response to the programmed signals to activate selected channels; and (h) moving the deposition sub-system and the platform relative to one another in response to the programmed signals.

As indicated earlier, the most popular file format used by commercial rapid prototyping machines is the .STL format, which describes the surface topology of a CAD model as a single surface represented by triangular facets. By slicing through the CAD model simulated by these triangles, one obtains coordinate points that define the boundaries of each cross section. It is therefore convenient for a dispensing nozzle to follow these coordinate points to trace out the perimeters of a layer cross section. These perimeters may be built with a proper material composition pattern and, since the exterior colors are normally what a person sees, the material composition patterns (including a color pattern) of the perimeters of constituent layer cross sections are normally more important than those of the interior of an object.

The above considerations have led to the development of another embodiment of the present invention. This is a process as set forth in the above-cited four steps, (a) through (d), wherein the moving step includes the step of moving the deposition device and the platform relative to one another in a direction parallel to the X-Y plane according to a first predetermined pattern to form an outer boundary of one selected material composition or one desired color pattern onto the platform. The outer boundary defines an exterior surface of the object.

Another embodiment is a process as set forth in the above paragraph, wherein the outer boundary defines an interior space in the object, and the moving step further includes the step of moving the deposition sub-system and the platform relative to one another in one direction parallel to the X-Y plane according to at least one other predetermined pattern to fill this interior space with a mixture of liquid compositions and powder materials. The interior does not need to have the same color or material composition as the exterior boundary. The interior space may be built with materials of a spatially controlled composition comprising one or more distinct types of materials. The powder particles may be deposited in continuously varying concentrations of distinct types of materials. This process may further comprise the steps of (f) creating an image of the object on a computer with the image including a plurality of segments or data points defining the object; and (i) generating program signals corresponding to each of these segments or data points in a predetermined sequence, wherein the program signals determine the movement of the deposition sub-system and the platform relative to one another in the first predetermined pattern and at least one other predetermined pattern.

The above procedures of delineating a boundary of a cross section and filling in the interior space of the cross section may be automated by using a computer system. This can be achieved, by way of example and not limitation, by following these steps: (j) creating an image of the object on a computer with the image including a plurality of segments or data points defining the object; (k) generating program signals corresponding to each of the segments or data points in a predetermined sequence; (l) activating at least one liquid droplet-ejecting channel and the powder dispensing device to deposit mixtures of liquid and solid materials at predetermined proportions onto the surface where a layer is being made; and (m) during this dispensing step, moving the deposition sub-system and the object-supporting platform in response to the programmed signals relative to one another in the X-Y plane and in the Z-direction in a predetermined sequence of movements such that the liquid droplets and powder particles are dispensed in free space as a plurality of segments sequentially formed so that the last dispensed segment overlies at least a portion of the preceding segment to which it is in contact to form the object.

For use in a direct write fabrication process, the target surface may comprise a surface of a microelectronic or micro-electro-mechanical system (MEMS) device substrate. The process may further comprise a step of operating a laser beam to remove an amount of material from a selected location on the substrate. As a freeform fabrication process, the presently invented process may further comprise a step of operating a laser beam to remove a portion of the dispensed liquid composition and/or dispensed solid powder or to remove a portion of a reaction product between the dispensed liquid composition and the dispensed powder particles. This feature makes the present process not only a layer-additive, but also layer-subtractive technique.

Another preferred embodiment of the present invention provides a process for making a device or a three-dimensional object of spatially tailored material compositions. This process comprises the steps of: (a) creating an image of the device or object on a computer with the image including a plurality of segments or data points defining the object and each of the segments or data points being coded with a specific material composition; (b) evaluating the data files representing the device or object to locate any un-supported feature of the device or object, followed by defining a support structure for the un-supported feature and creating a plurality of segments or data points defining the support structure; (c) generating program signals corresponding to each of the segments or data points for both the device or object and the support structure in a predetermined sequence; (d) dispensing and depositing droplets of liquid compositions and solid powder particles of predetermined material compositions at predetermined proportions onto a target surface of an object-supporting platform and operating a directed energy beam to induce a chemical change or physical transition to the deposited liquid compositions and/or powder particles for forming the device or object and the support structure; (e) during the deposition step, moving the deposition sub-system and the object-supporting platform in response to the programmed signals relative to one another in a plane defined by first and second (X- and Y-) directions and in a third direction (Z-direction) orthogonal to the X-Y plane in a predetermined sequence of movements such that the material compositions are deposited in free space as a plurality of segments or beads sequentially formed so that the last deposited segment or bead overlies at least a portion of the preceding segment or bead that it is in contact with to form the support structure and the multi-material three-dimensional device or object.

The above steps may further comprise a step of operating a laser beam to remove a portion of the deposited liquid composition and/or the deposited solid powder or to remove a portion of a reaction product between the dispensed liquid composition and the dispensed powder particles. The above steps, if used in a direct write fabrication process in which a target surface comprises a surface of a microelectronic or micro-electro-mechanical system device substrate, may be coupled with an additional step of operating a laser beam to remove an amount of material from a selected location of the substrate. Clearly, the apparatus described can be adapted to readily accomplish the above procedures.

The present invention describes numerous apparatus, system and method aspects of direct write and freeform three-dimensional fabrication. Aspects of the invention provide for depositing a combination of liquid and solid constituents whose state is then changed, such as being solidified, in response to operation of a directed energy source. Numerous aspects and embodiments of this apparatus and system are described as well as various methods described to achieve different object objectives. It should be appreciated that these aspects of the invention can be practiced separately, or in various combinations thereof, without departing from the present invention.

Although the description above contains many details, these should not be construed as limiting the scope of the invention but as merely providing illustrations of some of the presently preferred embodiments of this invention. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

1. An apparatus for fabricating an object or device, comprising:
an object support platform;
means for depositing selected liquids and powders in a given proportion on said object support platform;
means for directing a sufficient amount of energy to said combination of deposited liquids and powders to induce a state change; and
means for generating relative motion between said object support platform and said means for depositing selected liquids and solids to define a three-dimensional object.

2. An apparatus as recited in claim 1, wherein said state change comprises solidification of the combination of liquid and solid materials.

3. An apparatus as recited in claim 1, wherein said object being fabricated comprises a three-dimensional structure.

4. An apparatus as recited in claim 1, wherein said device being fabricated comprises an electronic component, sensor, or micro-electro-mechanical system (MEMS).

5. An apparatus as recited in claim 1, wherein said selected liquids comprise one or more liquids selected from a plurality of liquids.

6. An apparatus as recited in claim 1, wherein said selected powders comprise one or more powders selected from a plurality of powders.

7. An apparatus as recited in claim 6, wherein said powders comprise particulated solids having a sufficiently small particle size to achieve a desired level of detail of the object being fabricated.

8. An apparatus as recited in claim 1, wherein said means for directing a sufficient amount of energy comprises a laser device.

9. An apparatus as recited in claim 8, wherein the frequency of said laser device is selected, or modulated, in response to the materials to which it is directed and the desired state of change sought.

10. An apparatus as recited in claim 1, wherein said object support platform can be configured to support a substrate, or other base member, upon which said depositing of selected liquids and powders is directed.

11. An apparatus for fabricating a objects and devices, comprising:
an object support platform;
a material deposition sub-system comprising,
(i) a liquid deposition device,
(ii) a powder deposition device, and
(iii) a directed energy source configured for being directed at the deposited liquid and powders on said object support platform to induce a state change; and
a motion device configured for generating relative motion between said object support platform and said material deposition sub-system during the deposition of liquids and solids while fabricating a device or object.

12. An apparatus as recited in claim 11, wherein said liquid deposition device is configured for supplying a selected amount or deposition rate of said liquid.

13. An apparatus as recited in claim 11, wherein said powder deposition device is configured for supplying a selected amount or feed rate of solid particulates.

14. An apparatus as recited in claim 13, wherein said powder deposition device is configured with a plurality of channels from which powders having different characteristics can be selectively deposited.

15. An apparatus as recited in claim 11, wherein said liquid droplet deposition device and said powder-dispensing device are positioned in such a manner that said ejected liquid droplets and said dispensed powder particles are deposited at substantially identical spots of said platform.

16. An apparatus as recited in claim 11, wherein said directed energy source comprises:
an energy source configured for emitting a beam of energy;
a beam director configured for directing the beam of energy to a desired location on an object being fabricated; and
a beam focusing assembly configured for focusing the energy of said beam of energy upon a desired size area.

17. An apparatus as recited in claim 11, wherein said directed energy source is selected from the group of energy sources consisting essentially of laser beams, infrared light sources, ultra-violet light sources, electron beams, ion beams, X-radiation sources, Gamma ray sources, plasma sources, and combinations thereof.

18. An apparatus as recited in claim 11, wherein said directed energy source is of sufficient intensity or frequency to induce a physical or chemical change in said dispensed liquid droplets, powder particles, or a mixture of dispensed liquid droplets and powder particles to generate a solidified or consolidated product.

19. An apparatus as recited in claim 11, further comprising a computer system configured for controlling the operation of said material deposition sub-system and said motion device in response to object information accessible to said computer system.

20. An apparatus as recited in claim 11, further comprising:
a depth sensor configured for registering the depth of a single deposited layer or the accumulated depth of layers; and
programming adapted for execution on a control computer for modulating layer deposition by said material deposition sub-system in response to registering the data received from said depth sensor.

21. An apparatus as recited in claim 11, wherein said means for directing a sufficient amount of energy comprises a laser device.

22. An apparatus as recited in claim 21, wherein the frequency of said laser device is selected, or modulated, in response to the materials to which it is directed and the desired state of change sought.

23. An apparatus as recited in claim 11, wherein said directed energy source is configured for being directed at the combination of deposited liquid and powders on said object support platform to induce solidification.

24. An apparatus as recited in claim 11, wherein said object being fabricated comprises a three-dimensional structure.

25. An apparatus as recited in claim 11, wherein said device being fabricated comprises an electronic component, sensor, or micro-electro-mechanical system (MEMS).

26. An apparatus for performing direct write and solid freeform fabrication of devices and three-dimensional objects, comprising:
(a) an object-supporting platform;
(b) a material deposition sub-system disposed a distance to said platform, comprising,
(i) a liquid droplet deposition device, having at least one flow channel with said channel being supplied with a liquid composition, at least one nozzle having a fluid passage in flow communication with said channel and a discharge orifice of a desired size, and an actuator means located in control relation to said channel for activating ejection of liquid composition droplets toward selected spots of said platform,
(ii) a powder-dispensing device disposed a distance from said liquid droplet deposition device, and having at least one flow channel being supplied with solid powder particles, at least one nozzle having a flow passage in flow communication with said flow channel and a discharge orifice of a desired size to dispense powder particles toward selected spots of said platform, and an ultrasonic or vibration-based valve mechanism for controlling the amount of flow through said flow channel, and
(iii) a directed energy source configured for supplying energy to said ejected liquid droplets and said dispensed powder particles to induce a chemical reaction or physical transition thereof; and
(c) at least one motion device coupled to said platform and said material deposition sub-system for moving said deposition sub-system and said platform relative to one another to deposit said liquid droplets and powder particles for forming said device or object.

27. An apparatus as recited in claim 26, wherein said liquid droplet deposition device comprises a device selected from the group of flow control devices consisting of an inkjet print-head, a solenoid valve, a gear pump, an extruder, a positive displacement pump, a piston, a pneumatic pump, a sprayer, or combination thereof.

28. An apparatus as recited in claim 26, wherein said liquid droplet deposition device and said powder-dispensing device are positioned in such a manner that said ejected liquid droplets and said dispensed powder particles are deposited at substantially identical spots of said platform.

29. An apparatus as recited in claim 26, wherein said liquid droplet deposition device comprises a plurality of separate liquid dispensing devices or at least a multiple-orifice liquid dispensing device.

30. An apparatus as recited in claim 26, further comprising:
a computer;
programming executable on said computer for performing computer-aided design configured for creating a three-dimensional image of a desired device or object, to convert said image into a plurality of segments or data points defining the object, and to generate programmed signals corresponding to each of said segments or data points in a predetermined sequence; and
a motion controller electronically linked to said computer and said motion devices and operative to actuate said motion device in response to said programmed signals for each of said segments or data points received from said computer.

31. An apparatus as recited in claim 30, wherein said programming for performing computer-aided design, comprises:
means for evaluating the data files representing the image of said object to locate any un-supported feature of the object;
means, responsive to the evaluating means locating an un-supported feature, for defining a support structure for said un-supported feature;
means for creating a plurality of segments or data points defining said support structure; and
means for generating programmed signals required by said material deposition sub-system to fabricate said support structure.

32. An apparatus as recited in claim 26, further comprising:
sensor means electronically linked to said computer and operative to provide layer dimension data to said computer;
programming executable on said computer for performing adaptive layer slicing to create new sets of layer data comprising segments defining the object in accordance with said layer dimension data acquired by said sensor means, and to generate programmed signals corresponding to each of said segments in a predetermined sequence.

33. An apparatus as recited in claim 26:
further comprising means for compacting the deposited materials containing solid powder particles; and
wherein said means for compacting is coupled to said material deposition sub-system.

34. An apparatus as recited in claim 26, wherein said directed energy source is selected from the group of energy sources consisting essentially of laser beams, infrared light sources, ultra-violet light sources, electron beams, ion beams, X-radiation sources, Gamma ray sources, plasma sources, and combinations thereof.

35. An apparatus as recited in claim 26, wherein said directed energy source is of sufficient intensity or frequency to induce a physical or chemical change in said dispensed liquid droplets, powder particles, or a mixture of dispensed liquid droplets and powder particles to generate a solidified or consolidated product.

36. An apparatus as recited in claim 26, wherein said directed energy source comprises a laser beam, beam-directing means, and beam-focusing means.

37. An apparatus as recited in claim 26, further comprising a beam controller for controlling the intensity, frequency, direction, size, and/or focusing of said laser beam.

38. An apparatus as recited in claim 26, wherein said powder-dispensing device comprises a multiplicity of channels to dispense a multiplicity of material compositions therethrough.

39. A method of freeform fabrication of three-dimensional objects and direct writing of devices, comprising:
(a) providing a target surface on an object-supporting platform;
(b) controlling a material deposition sub-system for dispensing a liquid composition and solid powder particles to selected locations on said target surface;
(c) operating a directed energy source for supplying energy to said dispensed liquid composition and said dispensed powder particles to induce a chemical reaction or physical transition thereof at said selected locations; and
(d) moving said deposition sub-system and said object-supporting platform, during said operating steps (b) and (c), relative to one another in a plane defined by first and second directions to form said dispensed liquid composition and said dispensed powder particles into said device or object.

40. A method as recited in claim 39, wherein the moving step further comprises:
moving said deposition sub-system and said platform relative to one another in a direction parallel to said plane to form a first layer of said dispensed liquid composition and powder particles on said target surface;
moving said material deposition sub-system and said platform away from one another in a third direction orthogonal to said plane by a desired layer thickness; and
dispensing a second layer of a liquid composition and powder particles, after the portion of said first layer adjacent to said deposition sub-system has substantially solidified, onto said first layer and operating a directed energy source to induce a chemical reaction or physical transition in said dispensed liquid composition, or powder particles, or their combination while simultaneously moving said platform and said deposition sub-system relative to one another in a direction parallel to said plane, whereby said second layer solidifies and adheres to said first layer.

41. A method as recited in claim 40, further comprising:
forming multiple layers of said liquid composition and solid powder particles on top of one another by repeated dispensing and depositing of said liquid composition and solid particles from said deposition sub-system and exposing said liquid composition and solid particles to a directed energy source as said platform and said deposition sub-system are moved relative to one another in a direction parallel to said plane, with said deposition sub-system and said platform being moved away from one another in said third direction by a predetermined layer thickness after each preceding layer has been formed and with the depositing of each successive layer being controlled to take place after said deposited liquid composition or a reaction product of said deposited liquid composition with said powder particles in the preceding layer immediately adjacent said deposition sub-system have substantially solidified.

42. A method as recited in claim 39, wherein said directed energy source is of sufficient energy or intensity to induce a chemical reaction between said dispensed liquid and said dispensed powder.

43. A method as recited in claim 39, further comprising:
creating an image of said device or said three-dimensional object on a computer with said image including a plurality of segments or data points defining the object;
generating programmed signals corresponding to each of said segments or data points in a predetermined sequence; and
moving said deposition sub-system and said platform relative to each other in response to said programmed signals.

44. A method as recited in claim 43, wherein said at least one liquid composition comprises a multiplicity of liquid compositions, or said powder-dispensing device comprises a multiplicity of channels for dispensing a multiplicity of powder material compositions, or both.

45. A method as recited in claim 44, further comprising:
creating an image of said device or three-dimensional object on a computer with said image including a plurality of segments or data points defining the object; each of said segments or data points being coded with a material composition;
generating programmed signals corresponding to each of said segments or data points in a predetermined sequence;
operating said material deposition sub-system in response to said programmed signals to selectively dispense and deposit desired powder particles and liquid compositions from one or more of said multiple at predetermined proportions; and
moving said deposition sub-system and said platform relative to one another in response to said programmed signals.

46. A method as recited in claim 45, wherein said moving step includes the step of moving said deposition sub-system and said platform relative to one another in a direction parallel to said plane according to a first predetermined pattern to form an outer boundary from at least one of said liquid compositions, or at least one of said powder compositions, or both, on said platform, said outer boundary defining an exterior surface of the object.

47. A method as recited in claim 46, wherein said outer boundary defines an interior space in the object, and said moving step further includes the step of moving said deposition sub-system and said platform relative to one another in one direction parallel to said plane according to at least one other predetermined pattern to fill said interior space with said liquid composition and powder particles.

48. A method as recited in claim 47, further comprising the steps of:
creating an image of said three-dimensional object on a computer, said image including a plurality of segments or data points defining said object; and
generating program signals corresponding to each of said segments or data points in a predetermined sequence;
wherein said program signals determine said movement of said deposition sub-system and said platform relative to one another in said first predetermined pattern and said at least one other predetermined pattern.

49. A method as recited in claim 48, wherein said interior space is deposited with a spatially controlled material composition comprising one or more distinct types of materials.

50. A method as recited in claim 49, wherein said interior space is deposited with a material composition in continuously varying concentrations of distinct materials in three-dimensional part space to form a spatially controlled material composition device or object.

51. A method as recited in claim 50, wherein said distinct types of materials are deposited at discrete locations in three-dimensional part space to form a spatially controlled material composition part.

52. A method as recited in claim 39, further comprising:
measuring periodically the dimensions of the device or object being built using a dimension sensor; and
determining the thickness and outline of individual layers of said liquid composition and powder particles deposited in accordance with a computer aided design representation of said device or object;
wherein said determination is performed by calculating a first set of logical layers with specific thickness and outline for each layer and then periodically re-calculating another set of logical layers after comparing the dimension data acquired by said sensor means with the computer aided design representation in an adaptive manner.

53. A method as recited in claim 39:
wherein said liquid composition comprises a polymer component dissolved in a liquid solvent or a solid particle phase dispersed in a liquid medium; and
wherein said object platform is provided with ventilation means to rapidly remove said solvent or liquid medium upon deposition of said liquid composition.

54. A method as recited in claim 39, wherein said liquid composition comprises a melted solid material that rapidly solidifies upon deposition.

55. A method as recited in claim 39:
wherein said target surface comprises a surface of a microelectronic or micro-electro-mechanical system device substrate; and
wherein said direct writing method further comprises operating a laser beam to remove an amount of material from a selected location of said substrate.

56. A method as recited in claim 39, further comprising operating a laser beam to remove a portion of said dispensed liquid composition, or said dispensed solid powder, or both, or to remove a portion of a reaction product between said dispensed liquid composition and said dispensed powder particles.

57. A method as recited in claim 39, wherein said target surface comprises a surface of a substrate for a device selected from the group of devices consisting essentially of bio-sensors, chemical sensors, physical sensors, actuators, micro-electro-mechanical systems, micro-electronic devices, telecommunication devices, and combinations thereof.

58. A method as recited in claim 39, wherein said liquid composition or said solid powder is selected from the group of materials consisting essentially of:
metal material, including silver, nickel, gold, copper, chromium, titanium, aluminum, platinum, palladium, and alloys thereof;
ceramic materials, including alumina (Al₂O₃), silica, and glasses;
dielectric materials, including alumina, magnesium oxide (MgO), yttrium oxide (Y₂O₃), zirconium oxide (ZrO₂), and cerium oxide (CeO₂);
ferroelectric materials, including barium titanate (BaTiO₃), strontium titanate (SrTiO₃), lead titanate (PbTiO₃), lead zirconate (PbZrO₃), potassium niobate (KNbO₃), strontium bismuth tantalate (SrBi₂Ta₂O₉), (Ba,Sr)TiO₃, and solid solution stoichiometric variations thereof;
piezoelectric materials, including ferroelectrics, quartz, AlN, and lead zirconate titanate;
ferrite materials, including yttrium iron garnet (Y₃Fe₅O₁₂), barium zinc ferrite (Ba₂Zn₂Fe₁₂O₁₉), hexagonal ferrites, barium ferrite, spinel ferrites, nickel zinc ferrites, manganese zinc ferrite, and magnetite (Fe₃O₄);
electro-optical ceramic materials, including lithium niobate (LiNbO₃), lithium tantalate (LiTaO₃), cadmium telluride (CdTe), and zinc sulfide (ZnS);
ceramic superconductor materials, including YBa₂Cu₃O₇-x (YBCO), T1₂CaBa₂Cu₃O₁₂, La1.4Sr0.6CuO₃, BiSrCACuO, BaKBiO, and halide doped fullerines;
chalcogenide materials, including SrS, ZnS, CaS, and PbS;
semiconductor materials, including Si, Ge, GaAs, and CdTe;
phosphor containing materials, including SrS:Eu, SrS:Ce, ZnS:Ag, Y2O₂:Eu, and Zn₂SiO₄:Mn;
transparent conductive oxide materials, including indium tin oxide, zinc oxide, tin oxide, indium oxide, and mixture thereof; and
bio- and chemical sensing elements.

59. A method of freeform fabrication of three-dimensional objects and direct writing of devices using spatially tailored material compositions, comprising:
(a) creating an image of said device or object on a computer, said image including a plurality of segments or data points defining said object, each of said segments or data points being coded with a specific material composition;
(b) evaluating the data files representing the device or object to locate any un-supported feature of the device or object, followed by defining a support structure for the un-supported feature and creating a plurality of segments or data points defining said support structure;
(c) generating program signals corresponding to each of said segments or data points for both said device or object and said support structure in a predetermined sequence;
(d) dispensing and depositing droplets of liquid compositions and solid powder particles of predetermined material compositions at predetermined proportions onto a target surface of an object-supporting platform and operating a directed energy beam to induce a chemical change or physical transition to said deposited liquid compositions, or powder particles, or both, for forming the device or object and the support structure; and
(e) moving said deposition sub-system and said object-supporting platform, during said deposition step, in response to said programmed signals relative to one another in a plane defined by first and second directions and in a third direction orthogonal to said plane in a predetermined sequence of movements such that said material compositions are deposited in free space as a plurality of segments or beads sequentially formed so that the last deposited segment or bead overlies at least a portion of the preceding segment or bead in contact therewith to form the support structure and the multi-material three-dimensional device or object.

60. A method as recited in claim 59, further comprising operating a laser beam to remove a portion of said deposited liquid composition, or said deposited solid powder, or both, or to remove a portion of a reaction product between said dispensed liquid composition and said dispensed powder particles.

61. A method as recited in claim 59, wherein said target surface comprises a surface of a microelectronic or micro-electro-mechanical system device substrate and said process further comprises a step of operating a laser beam to remove an amount of material from a selected location of said substrate.

62. A method as recited in claim 59, wherein said target surface comprises a surface of a substrate for a device selected from the group consisting of a bio-sensor, a chemical sensor, a physical sensor, an actuator, a micro-electro-mechanical system, a micro-electronic device, a telecommunication device, and combinations thereof.

63. A method as recited in claim 59, wherein said liquid composition or said solid powder is selected from the group of materials consisting essentially of:
metal material, including silver, nickel, gold, copper, chromium, titanium, aluminum, platinum, palladium, and alloys thereof;
ceramic materials, including alumina (Al₂O₃), silica, and glasses;
dielectric materials, including alumina, magnesium oxide (MgO), yttrium oxide (Y₂O₃), zirconium oxide (ZrO₂), and cerium oxide (CeO₂);
ferroelectric materials, including barium titanate (BaTiO₃), strontium titanate (SrTiO₃), lead titanate (PbTiO₃), lead zirconate (PbZrO₃), potassium niobate (KNbO₃), strontium bismuth tantalate (SrBi₂Ta₂O₉), (Ba,Sr)TiO₃, and solid solution stoichiometric variations thereof;
piezoelectric materials, including ferroelectrics, quartz, AlN, and lead zirconate titanate;
ferrite materials, including yttrium iron garnet (Y₃Fe₅O₁₂), barium zinc ferrite (Ba₂Zn₂Fe₁₂O₁₉), hexagonal ferrites, barium ferrite, spinel ferrites, nickel zinc ferrites, manganese zinc ferrite, and magnetite (Fe₃O₄);
electro-optical ceramic materials, including lithium niobate (LiNbO₃), lithium tantalate (LiTaO₃), cadmium telluride (CdTe), and zinc sulfide (ZnS);
ceramic superconductor materials, including YBa₂Cu₃O₇-x (YBCO), Tl₂CaBa₂Cu₃O₁₂, La1.4Sr0.6CuO₃, BiSrCACuO, BaKBiO, and halide doped fullerines;
chalcogenide materials, including SrS, ZnS, CaS, and PbS;
semiconductor materials, including Si, Ge, GaAs, and CdTe;
phosphor containing materials, including SrS:Eu, SrS:Ce, ZnS:Ag, Y2O₂:Eu, and Zn₂SiO₄:Mn;
transparent conductive oxide materials, including indium tin oxide, zinc oxide, tin oxide, indium oxide, and mixture thereof; and
bio- and chemical sensing elements.
